(19) United States
(12) Patent Application Publication
(10) Pub. No.: US 2016/0259598 A1
(43) Pub. Date: Sep. 8, 2016

(54) CONTROL APPARATUS, CONTROL METHOD, AND CONTROL PROGRAM

(71) Applicant: FUJITSU LIMITED, Kawasaki-shi (JP)

(72) Inventors: Kazuhiko IKEUCHI, Kawasaki (JP); Chikashi Maeda, Kawasaki (JP); Kazuhiro Urata, Kawasaki (JP); Yukari Tsuchiyama, Kawasaki (JP); Takeshi Watanabe, Kawasaki (JP); Guangyu Zhou, Kawasaki (JP)

(73) Assignee: FUJITSU LIMITED, Kawaski-shi (JP)

(21) Appl. No.: 15/041,614

(22) Filed: Feb. 11, 2016

(30) Foreign Application Priority Data
Mar. 5, 2015 (JP) 2015-043511

(51) Int. Cl. G06F 3/06

(52) U.S. Cl. CPC G06F 3/0689; G06F 3/0604; G06F 3/0631

(57) ABSTRACT

A control apparatus, that controls allocation of data in a logical volume so that the data is allocated so as to span a plurality of RAID groups, according to a predetermined allocation pattern, includes a storage unit that stores correspondence information that includes at least one changing condition under which an allocation pattern for the data is changed and a new allocation pattern; and a control unit that identifies an access trend for each of the plurality of RAID groups, decides whether the logical volume satisfies the at least one changing condition, according to the correspondence information and the identified access trend, and reallocates, if the changing condition is satisfied, the data included in the logical volume according to the new allocation pattern corresponding to that changing condition.

### CROSS-REFERENCE TO RELATED APPLICATION

This application is based upon and claims the benefit of priority of the prior Japanese Patent Application No. 2015-043511, filed on Mar. 5, 2015, the entire contents of which are incorporated herein by reference.

### FIELD

The embodiment discussed herein is related to a control apparatus, a control method, and a control program.

### BACKGROUND

In a technology concerning a conventional redundant arrays of inexpensive disks (RAID) group, a plurality of storage devices are used to make data redundant and store the redundant data. In a logical unit number (LUN) linking technology, a plurality of RAID groups are used to create logical volumes. In a related technology, a desired data stripe ratio in a disk array apparatus including a plurality of disk units having different specifications is set according to individual disk unit specifications, for example. In another technology, a ratio of redundant storage by use of mirroring and parity is adjusted according to, for example, application properties. In yet another technology, storage areas are dynamically assigned to logical volumes. Examples of related art are described in Japanese Laid-open Patent Publication No. 8-63298, Japanese Laid-open Patent Publication No. 7-84732, and Japanese Laid-open Patent Publication No. 2007-140728.

However, the conventional technologies described above are problematic in that if a plurality of RAID groups in which logical volumes have been created by using the LUN linking technology are unevenly accessed, performance of accesses to logical volumes may be lowered.

In one aspect, an object of the present disclosure is to provide a control apparatus, a control method, and a control program that can suppress a reduction in access performance.

### SUMMARY

According to an aspect of the invention, a control apparatus that controls allocation of data included in a logical volume so that the data is allocated in a plurality of physical storage areas, which have been assigned so as to span a plurality of RAID groups, according to a predetermined allocation pattern, the control apparatus includes: a storage unit that stores correspondence information that includes at least one changing condition under which an allocation pattern for the data is changed and a new allocation pattern substituted for the allocation pattern in correspondence to each other; and a control unit that identifies an access trend for each of the plurality of RAID groups that are accessed in response to access requests for the logical volume, decides whether the logical volume satisfies the at least one changing condition, according to the correspondence information and the identified access trend, and reallocates, if the control unit decides that the at least one changing condition is satisfied, the data included in the logical volume according to the new allocation pattern corresponding to the at least one changing condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a control apparatus according an embodiment;

FIG. 2 illustrates an example of a storage system;

FIG. 3 illustrates an example of the data structure of an access table;

FIG. 4 is a block diagram illustrating an example of the functional structure of the control apparatus;

FIG. 5 illustrates an example of an access trend in each of a plurality of time periods;

FIG. 6 illustrates examples of values stored in the access table;

FIG. 7 illustrates an example of logical volume data reallocation by the control apparatus;

FIG. 8 illustrates examples of access trends after reallocation;

FIG. 9 illustrates examples of values stored in the access table after reallocation;

FIG. 10 is a flowchart illustrating an example of a monitoring procedure;

FIG. 11 is a flowchart illustrating an example of a selection procedure; and

FIG. 12 is a flowchart illustrating an example of a reallocation procedure.

### DESCRIPTION OF EMBODIMENT

An embodiment of a control apparatus, a control method, and a control program according to the present disclosure will be described in detail with reference to the drawings.

### Example of a Control Apparatus 100 According to an Embodiment

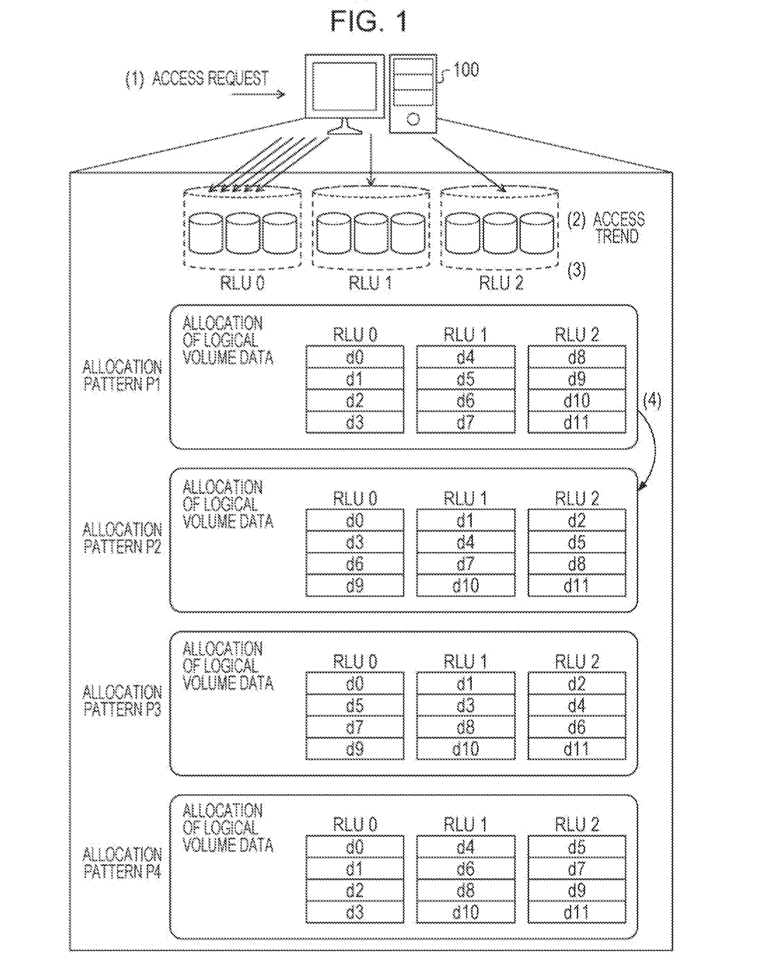

FIG. 1 illustrates an example of the control apparatus 100 according an embodiment. In FIG. 1, the control apparatus 100 is a computer that controls a plurality of RAID groups in which logical volumes have been created. Each RAID group is formed by use of one or a plurality of storage devices. The RAID group is also referred to as the RAID logical unit (RLU). Each storage device is, for example, a magnetic disk, an optical disk, a flash memory, a magnetic tape, or the like. Logical volumes are created by using the LUN linkage technology. Data in the logical volumes is distributed to and allocated in a plurality of RAID groups.

For example, there is an allocation pattern by which data in a logical volume is divided by the number of a plurality of RAID groups and each divided data is allocated in one of the plurality of RAID groups. In this allocation pattern, however, if data at the beginning of the logical volume is intended to be accessed in a concentrated manner, accesses are concentrated on an RAID group in which the data at the beginning of the logical volume is allocated. As a result, performance of accesses to the logical volume is lowered, and a storage unit is worn that includes the RAID group in which the data at the beginning of the logical volume is allocated. Access performance is, for example, an access speed. Specifically, access performance is a speed at which the control apparatus 100 accepts a request to access a logical volume and completes the access to the logical volume.

For example, there is another allocation pattern by which each predetermined amount of data in a logical volume is divided by the number of a plurality of RAID groups, and each divided data is allocated in one of the plurality of RAID groups so that each predetermined amount of data spans a plurality of RAID groups. In this allocation pattern, however, if data at the beginning of each predetermined amount of data is intended to be accessed in a concentrated manner, accesses are concentrated on an RAID group in which the data at the beginning is allocated. As a result, performance of accesses to the logical volume is lowered, and a storage unit is worn that includes the RAID group in which the data at the beginning is allocated.

As described above, in all of the plurality of allocation patterns by which data in a logical volume is distributed to and allocated in a plurality of RAID groups, performance of accesses to the logical volume may be lowered depending on the access trend in each of a plurality of RAID groups. An access trend indicates, for example, the number of accesses to one of a plurality of RAID groups, the presence or absence of a sequential access competition in one of the plurality of RAID groups, and the like. In this embodiment, a control method by which a reduction in access performance can be suppressed will be described. In this control method, it is possible to suppress a reduction in access performance by, for example, changing an allocation pattern according to the access trend in each of a plurality of RAID groups.

In the example in FIG. 1, the control apparatus 100 includes three RAID groups, denoted 0 to 2, in which to allocate data in a logical volume. The data in the logical volume in the example in FIG. 1 is a set of data d0 to d11 in segment units, to which contiguous logical addresses are assigned. A segment is a unit according to which data in a logical volume is segmented. Data in the logical volume is accessed as in, for example, access patterns A1 to A5 described below.

Access pattern A1 is a pattern by which data in a logical volume is randomly accessed a predetermined amount of data at a time. The predetermined amount of data is, for example, data in one segment unit. Specifically, access pattern A1 is a pattern by which data d0 to d11 are randomly accessed. Access pattern A2 is a pattern by which data from the beginning of a logical volume to its end is sequentially accessed. Specifically, access pattern A2 is a pattern by which data d0 to d11 are sequentially accessed.

Access pattern A3 is a pattern by which data in each of a plurality of areas in a logical volume is sequentially accessed. Specifically, access pattern A3 is a pattern by which data d0 to d3 are sequentially accessed, data d4 to d7 are sequentially accessed, and data d8 to d11 are sequentially accessed. Access pattern A4 is a pattern by which a plurality of discontiguous data items in a logical volume are accessed. Specifically, access pattern A4 is a pattern by which data d0, d3, d6, and d9 are accessed.

Access pattern A5 is a pattern by which data in some areas in a logical volume is sequentially accessed and data in the remaining areas in the logical volume is randomly accessed a predetermined amount of data at a time. The predetermined amount of data is, for example, data in segment units. Specifically, access pattern A5 is a pattern by which data d0 to d3 are sequentially accessed and data d4 to d11 are randomly accessed.

Although access patterns A1 to A5 have been described here as examples of access patterns, access patterns are not limited to access patterns A1 to A5. For example, access patterns may include a pattern by which data in some areas in a logical volume is randomly accessed a predetermined amount of data at a time. Specifically, access patterns may include a pattern by which data d0 to d3 are randomly accessed.

In the example in FIG. 1, allocation patterns P1 to P4 by which data d0 to d11 in a logical volume are allocated in a plurality of RAID groups are illustrated. Allocation pattern P1 is a pattern by which data in the logical volume is divided by the number of a plurality of RAID groups, starting from the beginning of the data, after which each divided data is allocated in one of the plurality of RAID groups. For example, allocation pattern P1 respectively allocates data d0 to d3, data d4 to d7, and data d8 to d11 in RAID groups 0 to 2.

In allocation pattern P1, if data is accessed as in, for example, access pattern A1, effects that cause a reduction in access performance are indeterminate. In allocation pattern P1, if data is accessed as in, for example, access pattern A2, RAID groups 0 to 2 are sequentially accessed one at a time, so it is not possible to concurrently access RAID groups 0 to 2. In allocation pattern P1, therefore, if data is accessed as in access pattern A2, access performance is lowered. In allocation pattern P1, if data is accessed as in, for example, access pattern A3, sequential accesses to RAID groups 0 to 2 are concurrently performed. In allocation pattern P1, therefore, if accesses are made as in access pattern A3, a reduction in access performance is suppressed.

Allocation pattern P2 is a pattern by which each of data items, in a logical volume, for the number of RAID groups is divided by the number of a plurality of RAID groups, starting from the beginning of the data in the logical volume, after which each divided data is allocated in one of the plurality of RAID group. For example, by allocation pattern P2, each of data d0 to d2, data d3 to d5, data d6 to d8, and data d9 to d11 for the number of RAID groups is divided by the number of RAID groups and the each divided data is allocated so as to span RAID groups 0 to 2. Specifically, by allocation pattern P2, data d0, d3, d6, and d9 are allocated in RAID group 0, data d1, d4, d7, and d10 are allocated in RAID group 1, and data d2, d5, d8, and d11 are allocated in RAID group 2.

In allocation pattern P2, if data is accessed as in, for example, access pattern A1, effects that cause a reduction in access performance are indeterminate. In allocation pattern P2, if data is accessed as in, for example, access pattern A2, sequential accesses to RAID groups 0 to 2 are concurrently performed. In allocation pattern P2, therefore, if data is accessed as in access pattern A2, a reduction in access performance is suppressed. In allocation pattern P2, if data is accessed as in, for example, access pattern A3, a sequential access competition occurs among RAID groups 0 to 2. In allocation pattern P2, therefore, if data is accessed as in access pattern A3, access performance is lowered. In allocation pattern P2, if data is accessed as in, for example, access pattern A4, accesses concentrate on RAID group 0. In allocation pattern P2, therefore, if data is accessed as in access pattern A4, access performance is lowered.

Allocation pattern P3 is a pattern by which each of data items, in a logical volume, for the number of RAID groups is divided by the number of a plurality of RAID groups, starting from the beginning of the data in the logical volume, after which the allocation order of each divided data is changed and each divided data is allocated in one RAID group in the substituted allocation order. For example, by allocation pattern P3, each of data d0 to d2, data d3 to d5, data d6 to d8, and data d9 to d11 is divided by the number of RAID groups, and they area allocated so as to span RAID groups 0 to 2 by changing their allocation order. Specifically, by allocation pattern P3, data d0, d5, d7, and d9 are allocated in RAID group 0, data d1, d3, d8, and d10 are allocated in RAID group 1, and data d2, d4, d6, and d11 are allocated in RAID group 2.

In allocation pattern P3, if data is accessed as in, for example, access pattern A1, effects that cause a reduction in access performance are indeterminate. In allocation pattern P3, if data is accessed as in, for example, access pattern A3, a sequential access competition occurs among RAID groups 0 to 2. In allocation pattern P3, therefore, if data is accessed as in access pattern A3, access performance is lowered. In allocation pattern P3, if data is accessed as in, for example, access pattern A4, accesses to RAID groups 0 to 2 are concurrently performed. In allocation pattern P3, therefore, if data is accessed as in access pattern A4, a reduction in access performance is suppressed.

Allocation pattern P4 is a pattern by which a predetermined amount of data, in a logical volume, starting from the beginning of data in the logical volume is allocated in one of a plurality of RAID groups, each predetermined amount of data in the remaining amount of data is divided by the number of remaining RAID groups, and each divided data is allocated in one remaining RAID group. For example, by allocation pattern P4, data d0 to d3 are allocated in RAID group 0. By allocation pattern P4, remaining data d4 to d6, remaining data d7 and d8, and remaining data d9 to d11 each are divided by the number of RAID groups and each divided data is allocated so as to span RAID groups 1 and 2. Specifically, by allocation pattern P4, data d0 to d3 are allocated in RAID group 0, data d4, d6, d8, and d10 are allocated in RAID group 1, and data d5, d7, d9, and d11 are allocated in RAID group 2.

In allocation pattern P4, if data is accessed as in, for example, access pattern A1, effects that cause a reduction in access performance are indeterminate. In allocation pattern P4, if data is accessed as in, for example, access pattern A3, a sequential access competition occurs between RAID groups 1 and 2. In allocation pattern P4, therefore, if data is accessed as in access pattern A3, access performance is lowered. In allocation pattern P4, if data is accessed as in, for example, access pattern A5, RAID group 0 is sequentially accessed independently and RAID groups 1 and 2 are randomly accessed. In allocation pattern P4, therefore, if data is accessed as in access pattern A5, a reduction in access performance is suppressed.

Although allocation patterns P1 to P4 have been described here as examples of allocation patterns, allocation patterns are not limited to access patterns P1 to P4. For example, allocation patterns may include a pattern by which a predetermined amount of data is allocated in one of a plurality of RAID groups, each predetermined amount of data in the remaining amount of data is divided by the number of remaining RAID groups, the allocation order of each divided data is changed, and each divided data is allocated in one remaining RAID group in the substituted allocation order.

In the example in FIG. 1, (1) the control apparatus 100 accepts an access request and accesses data in a logical volume in response to the access request. The example in FIG. 1 assumes that the logical volume data has bee allocated according to allocation pattern P1. The access request is a request to read out data or a request to write data. The access request indicates an area in the logical volume from which data is to be read out or to which data is to be written. The access request is also referred to as the IO (input/output) request.

(2) The control apparatus 100 obtains access requests that have been accepted within a predetermined period. The control apparatus 100 then identifies an access trend for each of a plurality of RAID groups according to the obtained access requests. An access trend indicates, for example, the number of accesses to each of the plurality of RAID groups, the presence or absence of a sequential access competition in each of the plurality of RAID groups, and the like.

(3) The control apparatus 100 references correspondence information in which a condition to change a data allocation pattern and a substituted allocation pattern are included in correspondence to each other, and decides whether the logical volume satisfies a changing condition, according to the access trends for the plurality of identified RAID groups. An example of the changing condition is such that a difference in the number of accesses is equal to or greater than a threshold between any two RAID groups in a plurality of RAID groups. Alternatively, the changing condition is such that there is a sequential access competition in any of a plurality of RAID groups. The changing condition may be broken into sub-conditions according to the size of data to be accessed. Specifically, if a difference in the number of accesses is greater than a threshold between any two RAID groups in a plurality of RAID groups, the control apparatus 100 decides that the changing condition is satisfied.

(4) If the control apparatus 100 decides that the changing condition is satisfied, the control apparatus 100 reallocates the logical volume data according to the substituted allocation pattern. In a case in which, for example, a difference in the number of accesses is greater than a threshold between any two RAID groups in a plurality of RAID groups, if the logical volume data has been allocated according to allocation pattern P1, the control apparatus 100 selects allocation pattern P2. The control apparatus 100 then reallocate the logical volume data according to the selected allocation pattern P2.

Thus, in a case in which, if logical volume data is allocated by using the current allocation pattern, a plurality of RAID groups would be unevenly accessed or an access competition would occur, the control apparatus 100 can change the allocation pattern. As a result, the control apparatus 100 can suppress uneven accesses to the plurality of RAID groups or an access competition among them and can thereby suppress a reduction in access performance and the wear of the RAID groups.

(Example of a Storage System 200)

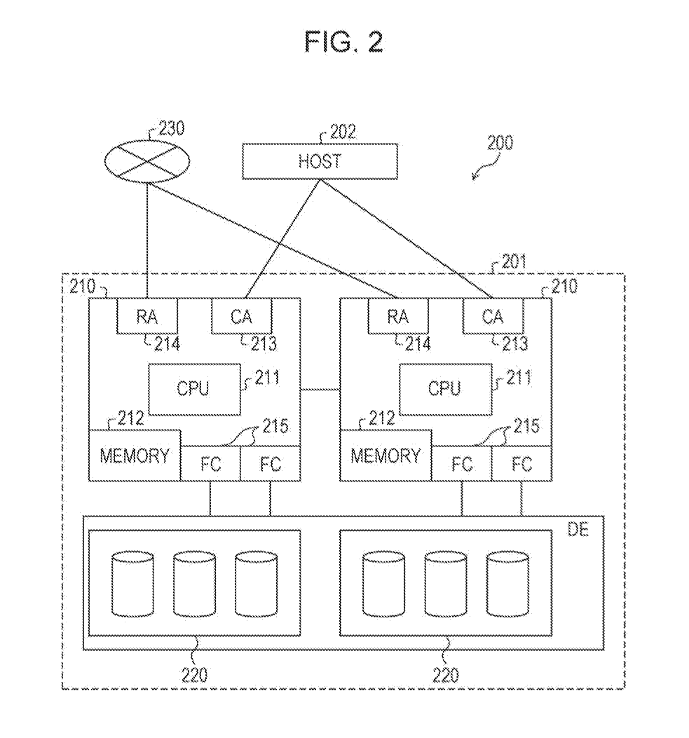

Next, an example of a storage system 200 to which the control apparatus 100 illustrated in FIG. 1 is applied will be described with reference to FIG. 2.

FIG. 2 illustrates an example of the storage system 200. In FIG. 2, the storage system 200 includes an RAID apparatus 201 and a host apparatus 202. The RAID apparatus 201 is, for example, a computer that operates as the control apparatus 100 in FIG. 1.

The RAID apparatus 201 includes two control modules (CMs) 210 and two storage units 220. Each CM 210 includes a central processing unit (CPU) 211, a memory 212, a channel adapter (CA) 213, a remote adapter (RA) 214, and a fibre channel (FC) 215.

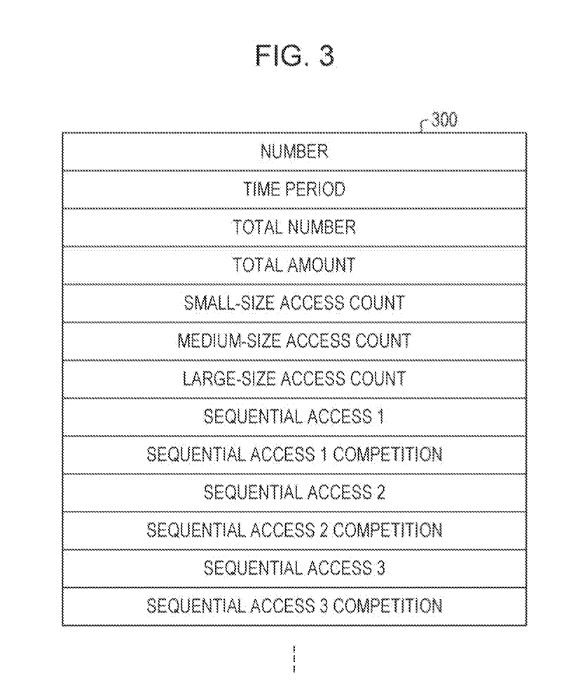

The CPU 211 governs the entire control of the CM 210. The CPU 211 operates the CM 210 by, for example, executing a program stored in the memory 212. The memory 212 stores a boot program and various tables including an access table 300, which will be described later with reference to FIG. 3. The memory 212 is also used as a work area employed by the CPU 211. The memory 212 includes, for example, a read-only memory (ROM), a random-access memory (RAM), a flash ROM, and the like.

The flash ROM stores specifically an operating system (OS) and other programs such as firmware. The ROM stores specifically application programs. The RAM is used specifically as a work area employed by the CPU 211. The RAM stores specifically various tables including the access table 300, which will be described later with reference to FIG. 3. When a program stored in the memory 212 is loaded in the CPU 211, the program causes the CPU 211 to perform coded processing.

The CA 213 controls interfaces to the host apparatus 202 and other external apparatuses. The RA 214 controls interfaces to external apparatuses that are connected through a network 230 or private lines. The FC 215 controls interfaces to the storage unit 220. The storage unit 220, which includes RAID groups, is used to create logical volumes. The storage unit 220 includes, for example, one or a plurality of hard disk drives (HDDs) and solid state discs (SSDs). The storage unit 220 is mounted in a disk enclosure (DE).

The host apparatus 202 is, for example, a computer that transmits a write request and the like to the RAID apparatus 201. Specifically, the host apparatus 202 is a personal computer (PC), a notebook PC, a mobile telephone, a smartphone, a tablet terminal, a personal digital assistant (PDA), or the like.

Although a case in which the RAID apparatus 201 includes two CMs 210 has been described here, this is not a limitation; for example, the RAID apparatus 201 may include one CM 210 or four or more CMs 210. Although a case in which the CM 210 includes one CA 213, one RA 214, and one FC 215 has been described here, this is not a limitation; for example, the CM 210 may include two or more CAs 213, RAs 214, or FCs 215.

Although a case in which the RAID apparatus 201 operates as the control apparatus 100 illustrated in FIG. 1 has been described, this is not a limitation; for example, each CM 210 may operate as the control apparatus 100 in FIG. 1. Alternatively, one of the CMs 210 may operate as the control apparatus 100 in FIG. 1.

Data Structure of the Access Table 300)

Next, an example of the data structure of the access table 300 will be described with reference to FIG. 3. The access table 300 is created by, for example, using a storage area in the memory 212 illustrated in FIG. 2.

FIG. 3 illustrates an example of the data structure of the access table 300. As illustrated in FIG. 3, the access table 300 includes a time period item, a total number item, a total amount item, a small-size access count item, a medium-size access count item, and a large-size access count item, in correspondence to a No. item. The time period item implies that the usage mode of the storage system 200 varies depending on whether the time period is during the morning, day, or night in a day, during a weekday or holiday in a week, or during a season in a year. Usage modes are, for example, online processing and batch processing.

The access table 300 further includes a sequential access 1 item, a sequential access 1 competition item, a sequential access 2 item, a sequential access 2 competition item, a sequential access 3 item, and a sequential access 3 competition item. The access table 300 stores records when information is set in the above items for each RAID group, which implements a logical volume.

The No. item stores a number assigned to an RAID group in which to create a logical volume. The time period item stores a time period during which the logical volume is used. The total number item stores a total number of accesses that were made, during the time period in the time period item, to an RAID group to which the number in the No. item had been assigned. The total amount item stores a total amount of data sizes in accesses that were made, during the time period in the time period item, to an RAID group to which the number in the No. item had been assigned.

The small-size access count item stores the number of small-size accesses that were made, during the time period in the time period item, to an RAID group to which the number in the No. item had been assigned. The small size is, for example, a data size that is at most half of the size of data in segment units.

The medium-size access count item stores the number of medium-size accesses that were made, during the time period in the time period item, to an RAID group to which the number in the No. item had been assigned. The medium size is, for example, a data size that is greater than half of the size of data in segment units and at most the size of data in segment units.

The large-size access count item stores the number of large-size accesses that were made, during the time period in the time period item, to an RAID group to which the number in the No. item had been assigned. The large size is, for example, a data size that is greater than the size of data in segment units.

If sequential accesses were made, during the time period in the time period item, in an RAID group to which the number in the No. item had been assigned, the sequential access 1 item stores the access range of the sequential accesses. The sequential access 1 competition item stores information as to whether a competition with another sequential access occurred within the access range of the sequential accesses in the sequential access 1 item.

If sequential accesses were made, during the time period in the time period item, in an RAID group to which the number in the No. item had been assigned, the sequential access 2 item stores the access range of the sequential accesses. The sequential access 2 competition item stores information as to whether a competition with another sequential access occurred within the access range of the sequential accesses in the sequential access 2 item.

If sequential accesses were made, during the time period in the time period item, in an RAID group to which the number in the No. item had been assigned, the sequential access 3 item stores the access range of the sequential accesses. The sequential access 3 competition item stores information as to whether a competition with another sequential access occurred within the access range of the sequential accesses in the sequential access 3 item.

The access table 300 may further include a sequential access 4 item, a sequential access 4 competition item, . . . , a sequential access n item, and a sequential access n competition item (n is a natural number). A sequential access item is added each time a new sequential access range is detected. Thus, the access table 300 can store access ranges of sequential accesses to RAID groups up to n times and information as to whether a competition with another sequential access occurred within the access ranges of the sequential accesses up to n times.

(Example of the Functional Structure of the Control Apparatus 100)

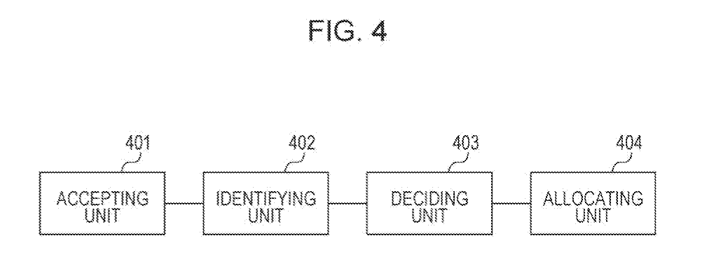

Next, an example of the functional structure of the control apparatus 100 will be described with reference to FIG. 4.

FIG. 4 is a block diagram illustrating an example of the functional structure of the control apparatus 100. The control apparatus 100 includes an accepting unit 401, an identifying unit 402, a deciding unit 403, and an allocating unit 404 as functions that enable the control apparatus 100 to function as a control unit.

The accepting unit 401 accepts access requests for logical volumes created by a plurality of RAID groups. The accepting unit 401 accepts an access request by, for example, accepting an access request that includes a data size and an access range from the host apparatus 202. Then, the accepting unit 401 can output the access request to the identifying unit 402.

The access request that the accepting unit 401 has accepted is stored in, for example, the memory 212 illustrated in FIG. 2. The accepting unit 401 implements its functions by, for example, causing the CPU 211 to execute a program stored in the memory 212 or using the CA 213 and RA 214.

The identifying unit 402 identifies an access trend for each of a plurality of RAID groups according to the access requests that the accepting unit 401 has accepted. For example, the identifying unit 402 identifies an access trend for each of a plurality of RAID groups to be accessed according to the access requests that the accepting unit 401 has accepted. An access trend indicates, for example, the number of accesses to a RAID group, the presence or absence of a sequential access competition in the RAID groups, and the like.

The identifying unit 402 identifies, for example, the number of accesses to each of a plurality of RAID groups. Specifically, the identifying unit 402 identifies the number of accesses to each of a plurality of RAID groups 0 to 2 in an online processing time period, according to the access requests that the accepting unit 401 has accepted in the online processing time period. The identifying unit 402 sets the identified number of accesses in the access table 300 illustrated in FIG. 3. Thus, the identifying unit 402 can store, in the access table 300, information that indicates an access trend for each of a plurality of RAID groups.

The identifying unit 402 identifies, for example, the presence or absence of a sequential access competition in each of a plurality of RAID groups. Specifically, the identifying unit 402 identifies the presence or absence of a sequential access competition in each of a plurality of RAID groups 0 to 2 in an online processing time period, according to the access requests that the accepting unit 401 has accepted in the online processing time period. The identifying unit 402 sets the identification result as to the presence or absence of a sequential access competition in the access table 300 in FIG. 3. Thus, the identifying unit 402 can store, in the access table 300, information that indicates an access trend for each of a plurality of RAID groups.

The identifying unit 402 may further identify a total number of accesses to a plurality of RAID groups according to access requests. Specifically, the identifying unit 402 identifies a total number of accesses to a plurality of RAID groups 0 to 2 in an online processing time period, according to the access requests that the accepting unit 401 has accepted in the online processing time period. Thus, the identifying unit 402 can store, in the access table 300, information that indicates an access trend for each of a plurality of RAID groups.

The information that indicates the access trend identified by the identifying unit 402 is stored in, for example, the memory 212 illustrated in FIG. 2. The identifying unit 402 implements its functions by, for example, causing the CPU 211 to execute a program stored in the memory 212.

The deciding unit 403 references correspondence information in which correspondences are made between conditions under which data allocation patterns are changed and substituted allocation patterns, and decides whether a logical volume satisfies the relevant changing condition according to an access trend identified for each of a plurality of RAID groups. In the correspondence information, correspondences are made between a plurality of branching conditions used as changing conditions and allocation patterns, each of which is selected as a substituted allocation pattern when one of the plurality of branching conditions is satisfied. The correspondence information may be created as part of a program. Alternatively, the correspondence information may be a table in which correspondences are made between changing conditions and substituted allocation patterns. The correspondence information only has to be stored in the memory 212 or another non-volatile storage unit as structural information about a program or table information.

The correspondence information is, for example, information in which a second allocation pattern, which is a substituted allocation pattern, is associated with the condition that a difference in the number of accesses is greater than a threshold between any two RAID groups in a plurality of RAID groups and the condition that the current allocation pattern is a first allocation pattern. Alternatively, the correspondence information may be information in which a fourth allocation pattern, which is a substituted allocation pattern, is associated with the condition that there is a sequential access competition and the condition that data involved in sequential accesses can be allocated in any one of a plurality of RAID groups in a concentrated manner.

An allocation pattern is, for example, one of the first allocation pattern to a fifth allocation pattern. The first allocation pattern is a pattern by which data in a logical volume is divided by the number of a plurality of RAID groups and each divided data is allocated in one of the plurality of RAID groups. The first allocation pattern is, for example, a pattern by which data in a logical volume is contiguously distributed and allocated across a plurality of RAID groups. Specifically, the first allocation pattern is allocation pattern P1 illustrated in FIG. 1. The second allocation pattern is a pattern by which each of data items, in a logical volume, in segment units for the number of RAID groups is divided by the number of a plurality RAID groups and each divided data is allocated in one of a plurality of divided RAID groups. The second allocation pattern is, for example, a pattern by which a predetermined amount of data in a logical volume is distributed to and allocated in each of a plurality of RAID groups at a time so that the data is contiguously distributed and allocated across the RAID groups. Specifically, the second allocation pattern is allocation pattern P2 illustrated in FIG. 1.

The third allocation pattern is a pattern by which an order in which data in a logical volume is allocated in a plurality of RAID groups is changed and the data is allocated in the substituted allocation order. The third allocation pattern is, for example, a pattern by which each of data items, in a logical volume, in segment units for the number of RAID groups is divided by the number of a plurality RAID groups, after which an order in which each divided data is allocated in one of a plurality of divided RAID groups is changed and the data is allocated in the substituted allocation order. Specifically, the third allocation pattern is allocation pattern P3 illustrated in FIG. 1. The fourth allocation pattern is a pattern by which data involved in sequential accesses is allocated in any one of a plurality of RAID groups in a concentrated manner. The fourth allocation pattern is also a pattern by which the remaining data in data in a logical volume is distributed to and allocated in the remaining RAID groups in the plurality of RAID groups. The fourth allocation pattern is, for example, a pattern by which the remaining data is distributed to and allocated in the remaining RAID groups for each of data items in segment units for the number of RAID groups. The data involved in sequential accesses is, for example, data that has been sequentially accessed. The fourth allocation pattern is specifically allocation pattern P4 illustrated in FIG. 1.

The fifth allocation pattern is a pattern by which data involved in sequential accesses is allocated in any one of a plurality of RAID groups in a concentrated manner. The fifth allocation pattern is also a pattern by which the remaining data is divided by the number of remaining RAID groups for each of data items in segment units for a multiple of the number of RAID groups, after which each divided data is distributed and allocated in one of the remaining RAID groups. The fifth allocation pattern is, for example, a pattern by which a predetermined amount of data in the remaining data is distributed to and allocated in the remaining RAID groups at a time so that the data is contiguously distributed and allocated across the remaining RAID groups.

The deciding unit 403 decides that a first changing condition of the changing conditions is satisfied if, for example, a difference in the number of accesses is greater than a threshold between any two RAID groups in a plurality of RAID groups. Specifically, if the number of accesses to RAID group 0, the number having been identified by the identifying unit 402, is greater than twice the number of accesses to RAID group 1, the number having been identified by the identifying unit 402, the deciding unit 403 decides that the first changing condition of the changing conditions is satisfied. Thus, by deciding whether there is an unevenness in the number of accesses between any two RAID groups in a plurality of RAID groups, the deciding unit 403 can decide whether to change the allocation pattern for the logical volume data.

The deciding unit 403 decides that a second changing condition of the changing conditions is satisfied if, for example, there is a sequential access competition in any one of a plurality of RAID groups. Specifically, if there is a sequential access competition in RAID group 0, the deciding unit 403 decides that the second changing condition of the changing conditions is satisfied. Thus, by deciding whether there is a sequential access competition in any one of a plurality of RAID groups, the deciding unit 403 can decide whether to change the allocation pattern for the logical volume data.

The deciding unit 403 decides that a third changing condition of the changing conditions is satisfied if there is a sequential access competition in any one of a plurality of RAID groups and a difference in the number of accesses is greater than a threshold between any two RAID groups in the remaining RAID groups. Specifically, if there is a sequential access competition in RAID group 0 and the number of accesses to RAID group 1 is larger than twice the number of accesses to RAID group 2, the deciding unit 403 decides that the third changing condition of the changing conditions is satisfied. Thus, the deciding unit 403 can decide whether to change the allocation pattern for the logical volume data.

The deciding unit 403 identifies whether the current allocation pattern is any one of a plurality of allocation patterns. For example, the deciding unit 403 identifies whether the current allocation pattern is any one of the first allocation pattern to the fourth allocation pattern. Specifically, the deciding unit 403 identifies whether the current allocation pattern is any one of allocation patterns P1 to P4 illustrated in FIG. 1. Thus, the deciding unit 403 can identify the current allocation pattern that is used when a substituted allocation pattern is selected.

If the total number identified by the identifying unit 402 is greater than a threshold, the deciding unit 403 may decide whether a changing condition is satisfied. If the total number identified by the identifying unit 402 is equal to or smaller than the threshold, the deciding unit 403 may cause the allocating unit 404 not to reallocate logical volume data without deciding whether a changing condition is satisfied. Thus, if a total number of accesses to a plurality of RAID groups is smaller than a threshold and performance of accesses to logical volumes is not easily lowered in spite of the allocation pattern being left unchanged, the deciding unit 403 can leave the allocation pattern unchanged. As a result, the deciding unit 403 can reduce a load on reallocation of logical volume data.

Results of decisions by the deciding unit 403 are stored in, for example, the memory 212. The deciding unit 403 implements its functions by, for example, causing the CPU 211 to execute a program stored in the memory 212 illustrated in FIG. 2.

If the deciding unit 403 decides that a changing condition is satisfied, the allocating unit 404 reallocates logical volume data according to a substituted allocation pattern corresponding to the changing condition. In case in which, for example, the deciding unit 403 decides that the first changing condition is satisfied, if logical volume data to be reallocated has been allocated according to the first allocation pattern, the allocating unit 404 reallocates the logical volume data according to the second allocation pattern. The data to be reallocated is logical volume data. The data to be reallocated may be logical volume data corresponding to any RAID group, logical volume data for which the number of accesses is large, logical volume data involved in sequential accesses, or the like. Specifically, if the deciding unit 403 decides that the first changing condition is satisfied and that the current allocation pattern is allocation pattern P1, the allocating unit 404 reallocates logical volume data according to allocation pattern P2. Thus, the allocating unit 404 can equalize the number of accesses to each of a plurality of RAID groups.

In a case in which, for example, the deciding unit 403 decides that the first changing condition is satisfied, if logical volume data to be reallocated has been allocated according to the second allocation pattern, the allocating unit 404 reallocates the logical volume data according to the third allocation pattern. Specifically, if the deciding unit 403 decides that the first changing condition is satisfied and that the current allocation pattern is allocation pattern P2, the allocating unit 404 reallocates logical volume data according to allocation pattern P3. Thus, the allocating unit 404 can equalize the number of accesses to each of a plurality of RAID groups.

In a case in which, for example, the deciding unit 403 decides that the second changing condition is satisfied, if data that is involved in sequential accesses and is to be reallocated can be allocated in any one of a plurality of RAID groups in a concentrated manner, the allocating unit 404 reallocates the logical volume data according to the fourth allocation pattern. Specifically, in a case in which the deciding unit 403 decides that the second changing condition is satisfied, if sequentially accessed data can be allocated in any one of a plurality of RAID groups in a concentrated manner, the allocating unit 404 reallocates logical volume data according to allocation pattern P4. More specifically, the allocating unit 404 allocates all sequentially accessed data in any one of a plurality of RAID groups and distributes and allocates the remaining data to and in the remaining RAID groups. Thus, the allocating unit 404 can equalize the number of accesses to each of a plurality of RAID groups and can also increase efficiency by enabling sequential access to be performed in any one of the plurality of RAID groups.

In case in which, for example, the deciding unit 403 decides that the third changing condition is satisfied, if data that is involved in sequential accesses and is to be reallocated can be allocated in any one of a plurality of RAID groups in a concentrated manner, the allocating unit 404 reallocates logical volume data according to the fifth allocation pattern. Specifically, the allocating unit 404 allocates logical volume data so that sequentially accessed data is allocated in RAID group 0 and data that will be randomly accessed without being sequentially accessed is allocated in RAID groups 1 and 2. Thus, the allocating unit 404 can equalize the number of accesses to each of a plurality of RAID groups and can also increase efficiency by enabling data to be sequentially accessed in any one of a plurality of RAID groups.

If the deciding unit 403 decides that there is a sequential access competition, the allocating unit 404 may reallocate logical volume data so that data to be sequentially accessed is distributed to a plurality of RAID groups. The allocating unit 404 implements its functions by, for example, causing the CPU 211 to execute a program stored in the memory 212 illustrated in FIG. 2.

### Example in which the Control Apparatus 100 is Used

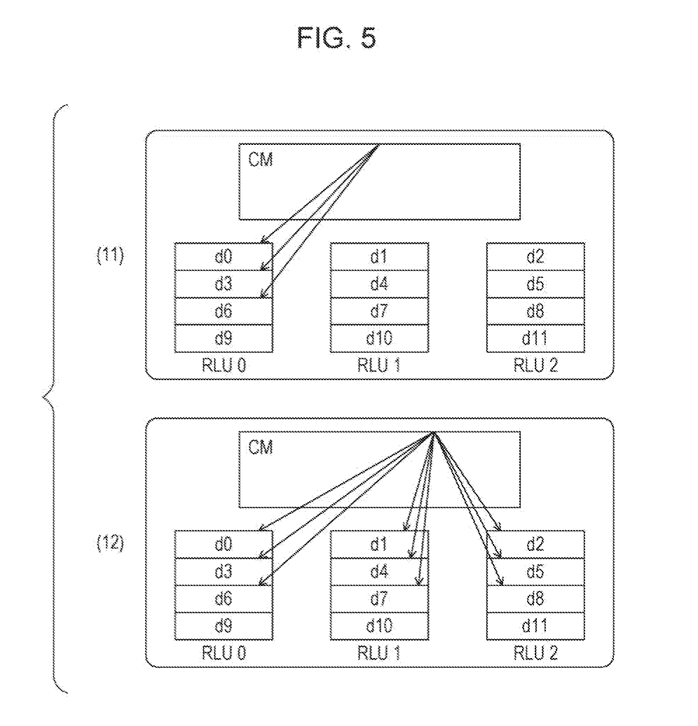

Next, an example in which the control apparatus 100 is used will be described with reference to FIGS. 5 to 9.

<Examples of Access Trends>

FIG. 5 illustrates an example of an access trend in each of a plurality of time periods. In the example in FIG. 5, logical volume data has been allocated in a plurality of RAID groups according to the second allocation pattern.

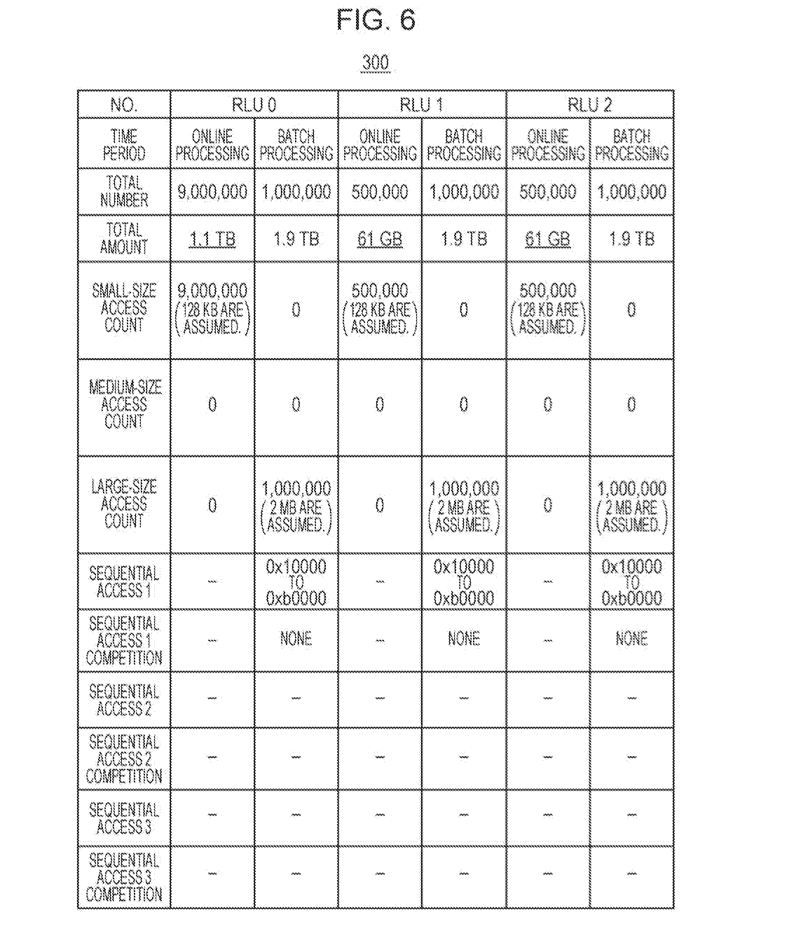

(11) In a time period in which online processing is performed, the control apparatus 100 accepts 9,000,000 small-size access requests for RAID group 0, 500,000 small-size access requests for RAID group 1, and 500,000 small-size access requests for RAID group 2. Each time the control apparatus 100 accepts an access request in a time period in which online processing is performed, the control apparatus 100 updates the items corresponding to “online processing”, in the time period item in the access table 300 as will be described later with reference to FIG. 6. Since accesses are concentrated on RAID group 0 here, access performance is lowered.

(12) In a time period in which batch processing is performed, the control apparatus 100 accepts 1,000,000 large-size access requests for each of RAID groups 0 to 2. Each time the control apparatus 100 accepts an access request in a time period in which batch processing is performed, the control apparatus 100 updates items corresponding to “batch processing” in the time period item, in the access table 300 as will be described later with reference to FIG. 6. Since accesses are evenly performed among RAID groups 0 to 2 here, a reduction in access performance is suppressed. Although a case in which the control apparatus 100 accepts small-size access requests and a case in which the control apparatus 100 accepts large-size access requests have been described, this is not a limitation; for example, the control apparatus 100 may accept small-size access requests, medium-size access requests, and large-size access requests.

<Examples of Values Stored in the Access Table 300>

FIG. 6 illustrates examples of values stored in the access table 300. As illustrated in FIG. 6, the control apparatus 100 sets numerals in the total number item, total amount item, and small-size access count item corresponding to “online processing” in the time period item at each of number items 0 to 2, according to the access requests accepted in (11) above. Specifically, the control apparatus 100 sets 9,000,000 in the total number item, 1.1 TB in the total amount item, and 9,000,000 in the small-size access count item in correspondence to “online processing” in the time period item at number item 0.

Specifically, in correspondence to “online processing” in the time period item at number item 1, the control apparatus 100 also sets 500,000 in the total number item, 61 GB in the total amount item, and 500,000 in the small-size access count item. Specifically, in correspondence to “online processing” in the time period item at number item 2, the control apparatus 100 also sets 500,000 in the total number item, 61 GB in the total amount item, and 500,000 in the small-size access count item.

Similarly, the control apparatus 100 sets numerals in the total number item, total amount item, and large-size access count item corresponding to “batch processing” in the time period item at each of number items 0 to 2, according to the access requests accepted in (12) above. The control apparatus 100 also sets numerals in the sequential access 1 item and sequential access 1 competition item corresponding to “batch processing” in the time period item at each of number items 0 to 2, according to the access requests accepted in (12) above. Specifically, the control apparatus 100 sets 1,000,000 in the total number item, 1.9 TB in the total amount item, and 1,000,000 in the large-size access count item in correspondence to “batch processing” in the time period item at number item 0. The control apparatus 100 also sets 0x10000 to 0xb0000 in the sequential access 1 item and “none” in the sequential access 1 competition item.

Specifically, in correspondence to “batch processing” in the time period item at number item 1, the control apparatus 100 also sets 1,000,000 in the total number item, 1.9 TB in the total amount item, and 1,000,000 in the large-size access count item. The control apparatus 100 also sets 0x10000 to 0xb0000 in the sequential access 1 item and “none” in the sequential access 1 competition item. Specifically, in correspondence to “batch processing” in the time period item at number item 2, the control apparatus 100 also sets 1,000,000 in the total number item, 1.9 TB in the total amount item, and 1,000,000 in the large-size access count item. The control apparatus 100 also sets 0x10000 to 0xb0000 in the sequential access 1 item and “none” in the sequential access 1 competition item.

The control apparatus 100 decides whether the changing condition is satisfied, with reference to the access table 300. If, for example, a difference in the number of accesses is equal to or greater than a threshold between any two RAID groups in a plurality of RAID groups, the control apparatus 100 decides that the changing condition is satisfied. In the example in FIG. 6, since a difference in the number of accesses is equal to or greater than the threshold between two RAID groups, the control apparatus 100 decides that the changing condition is satisfied. If the current allocation pattern is allocation pattern P2, the control apparatus 100 selects allocation pattern P3 as the substituted allocation pattern. Although a case in which the control apparatus 100 has used the small-size access count item, large-size access count item, and the like to decide whether the changing condition is satisfied, this is not a limitation; for example, the control apparatus 100 may further use the medium-size access count item and the like to decide whether the changing condition is satisfied.

<Example of Reallocating Logical Volume Data>

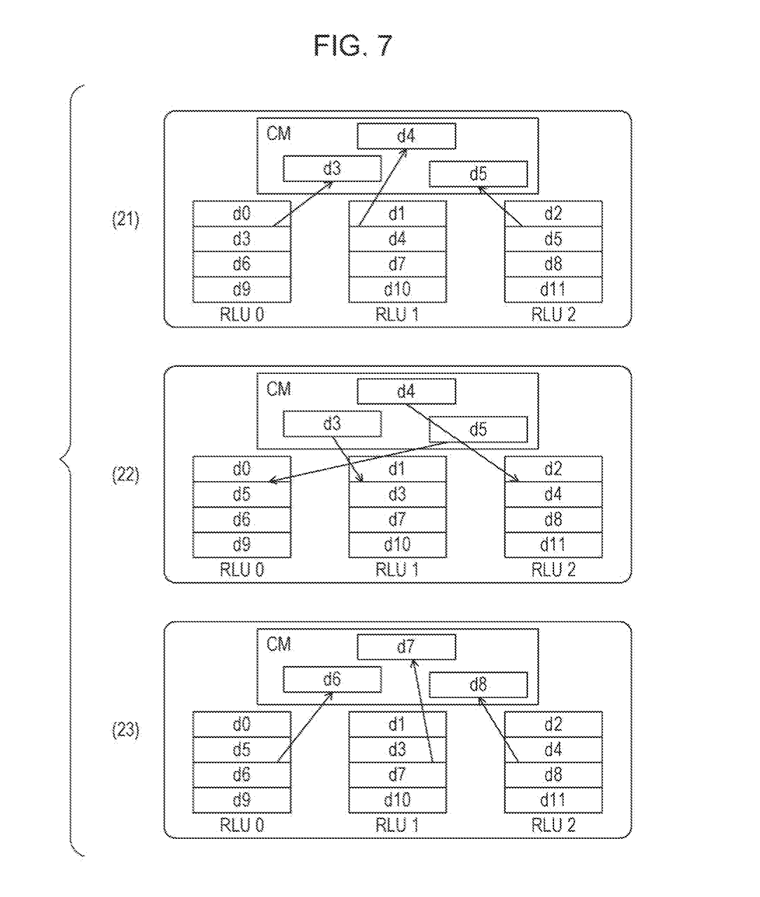

FIG. 7 illustrates an example of logical volume data reallocation by the control apparatus 100. The control apparatus 100 changes allocation pattern P2 to allocation pattern P3 and reallocates logical volume data with allocation pattern P3.

(21) The control apparatus 100 leaves, for example, data d0 to d2, in logical volume data, which are allocated in an area common to allocation pattern P2 and allocation pattern P3, as they are, without reading out them. The control apparatus 100 then reads out data d3 to d5, in the logical volume data, which have been allocated according to allocation pattern P2.

(22) The control apparatus 100 reallocates the read-out data d3 to d5 according to allocation pattern P3. Specifically, the control apparatus 100 allocates the read-out data d3 in RAID group 1, the read-out data d4 in RAID group 2, and the read-out data d5 in RAID group 0.

(23) Similarly, the control apparatus 100 reads out data d6 to d8, in the logical volume data, which have been allocated according to allocation pattern P2 and reallocates them according to allocation pattern P3. Thus, the control apparatus 100 can reallocate the logical volume data according to allocation pattern P3.

<Examples of Access Trends after Reallocation>

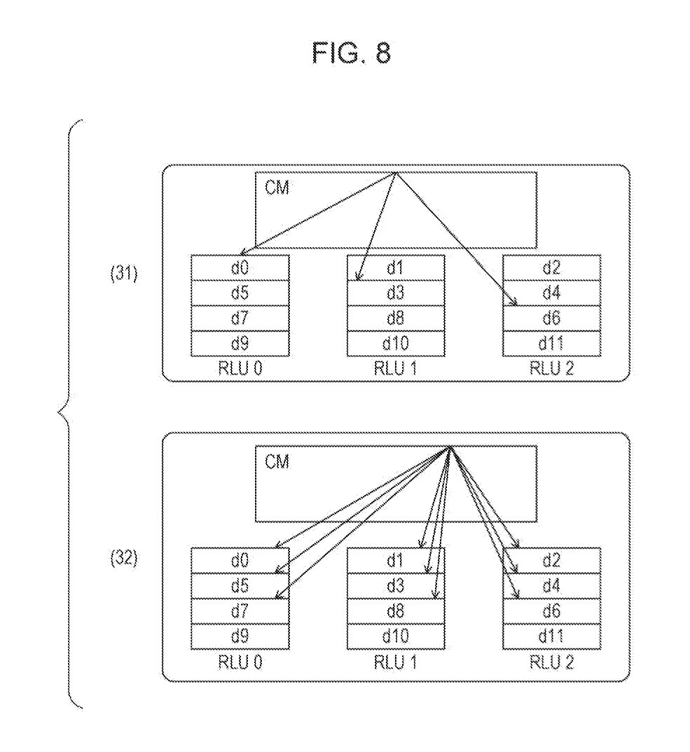

FIG. 8 illustrates examples of access trends after reallocation. In the examples in FIG. 8, the logical volume data is allocated in a plurality of RAID groups according to the third allocation pattern as a result of reallocation in FIG. 7.

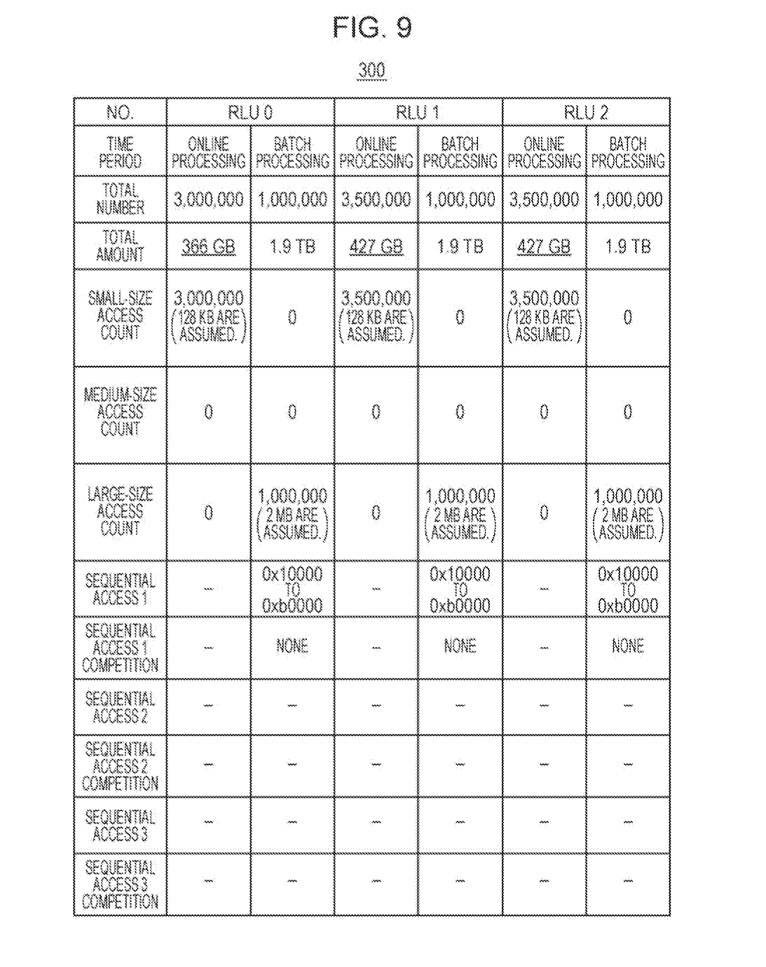

(31) In a time period in which online processing is performed, the control apparatus 100 accepts access requests as in (11). Specifically, the control apparatus 100 accepts 3,000,000 small-size access requests for RAID group 0, 3,500,000 small-size access requests for RAID group 1, and 3,500,000 small-size access requests for RAID group 2. Each time the control apparatus 100 accepts an access request in a time period in which online processing is performed, the control apparatus 100 updates the items corresponding to “online processing” in the time period item in the access table 300, which will be described later with reference to FIG. 9. Since RAID groups 0 to 2 are evenly accessed here, a reduction in access performance is suppressed.

(32) In a time period in which batch processing is performed, the control apparatus 100 accepts access requests as in (12). Specifically, the control apparatus 100 accepts 1,000,000 large-size access requests for each of RAID groups 0 to 2, sequential access being performed in response to each large-size access request. Each time the control apparatus 100 accepts an access request in a time period in which batch processing is performed, the control apparatus 100 updates the items corresponding to “batch processing” in the time period item in the access table 300, which will be described later with reference to FIG. 9. Since RAID groups 0 to 2 are evenly accessed here, a reduction in access performance is suppressed. As described above, after reallocation, even if access requests are accepted in a time period in which online processing is performed, as in (11), and even if even if access requests are accepted in a time period in which batch processing is performed, as in (12), a reduction in access performance is suppressed.

<Examples of Values Stored in the Access Table 300 after Reallocation>

FIG. 9 illustrates examples of values stored in the access table 300 after reallocation. As illustrated in FIG. 9, the control apparatus 100 sets numerals in the total number item, total amount item, and small-size access count item corresponding to “online processing” in the time period item at each of number items 0 to 2, according to the access requests accepted in (31) above. Specifically, the control apparatus 100 sets 3,000,000 in the total number item, 366 GB in the total amount item, and 3,000,000 in the small-size access count item in correspondence to “online processing” in the time period item at number item 0.

Specifically, in correspondence to “online processing” in the time period item at number item 1, the control apparatus 100 also sets 3,500,000 in the total number item, 427 GB in the total amount item, and 3,500,000 in the small-size access count item. Specifically, in correspondence to “online processing” in the time period item at number item 2, the control apparatus 100 also sets 3,500,000 in the total number item, 427 GB in the total amount item, and 3,500,000 in the small-size access count item.

Similarly, the control apparatus 100 sets numerals in the total number item, total amount item, and large-size access count item corresponding to “batch processing” in the time period item at each of number items 0 to 2, according to the access requests accepted in (32) above. The control apparatus 100 also sets numerals in the sequential access 1 item and sequential access 1 competition item corresponding to “batch processing” in the time period item at each of number items 0 to 2, according to the access requests accepted in (32) above. Specifically, the control apparatus 100 sets 1,000,000 in the total number item, 1.9 TB in the total amount item, and 1,000,000 in the large-size access count item in correspondence to “batch processing” in the time period item at number item 0. The control apparatus 100 also sets 0x10000 to 0xb0000 in the sequential access 1 item and “none” in the sequential access 1 competition item.

Specifically, in correspondence to “batch processing” in the time period item at number item 1, the control apparatus 100 also sets 1,000,000 in the total number item, 1.9 TB in the total amount item, and 1,000,000 in the large-size access count item. The control apparatus 100 also sets 0x10000 to 0xb0000 in the sequential access 1 item and “none” in the sequential access 1 competition item. Specifically, in correspondence to “batch processing” in the time period item at number item 2, the control apparatus 100 also sets 1,000,000 in the total number item, 1.9 TB in the total amount item, and 1,000,000 in the large-size access count item. The control apparatus 100 also sets 0x10000 to 0xb0000 in the sequential access 1 item and “none” in the sequential access 1 competition item.

The control apparatus 100 decides whether the changing condition is satisfied, with reference to the access table 300. If, for example, a difference in the number of accesses is equal to or greater than a threshold between any two RAID groups in a plurality of RAID groups, the control apparatus 100 decides that the changing condition is satisfied. In the example in FIG. 9, since a difference in the number of accesses is smaller than the threshold between two RAID groups, the control apparatus 100 decides that the changing condition is not satisfied. The control apparatus 100 then decides that the allocation pattern can be left unchanged because, with the current allocation pattern, a reduction in access performance can be suppressed.

(Example of a Monitoring Procedure)

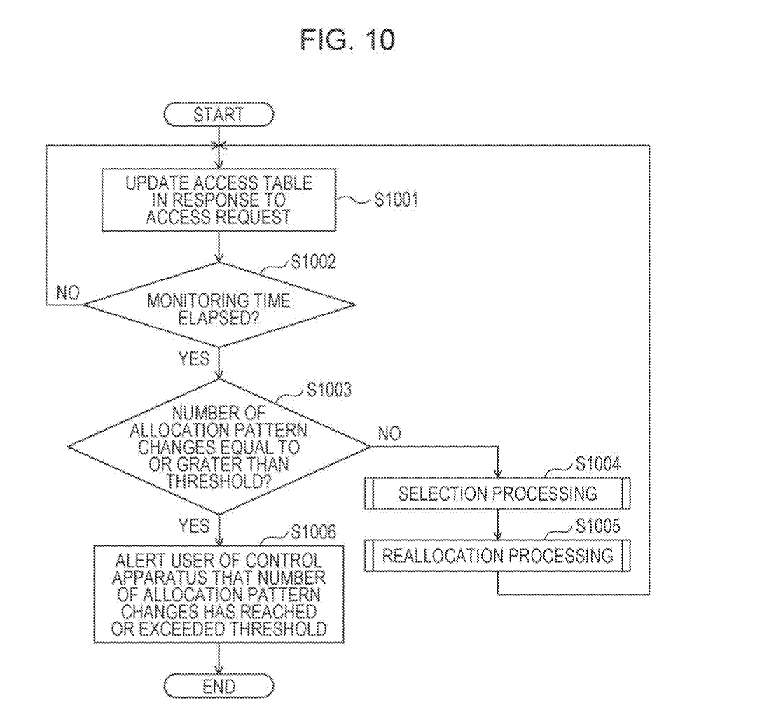

Next, an example of a monitoring procedure will be described with reference to FIG. 10.

FIG. 10 is a flowchart illustrating an example of the monitoring procedure. In FIG. 10, the control apparatus 100 updates the access table 300 in response to an access request (step S1001). The control apparatus 100 then decides whether a monitoring time has elapsed (step S1002). If the monitoring time has not elapsed (the result in step S1002 is No), the control apparatus 100 returns to processing in step S1001.

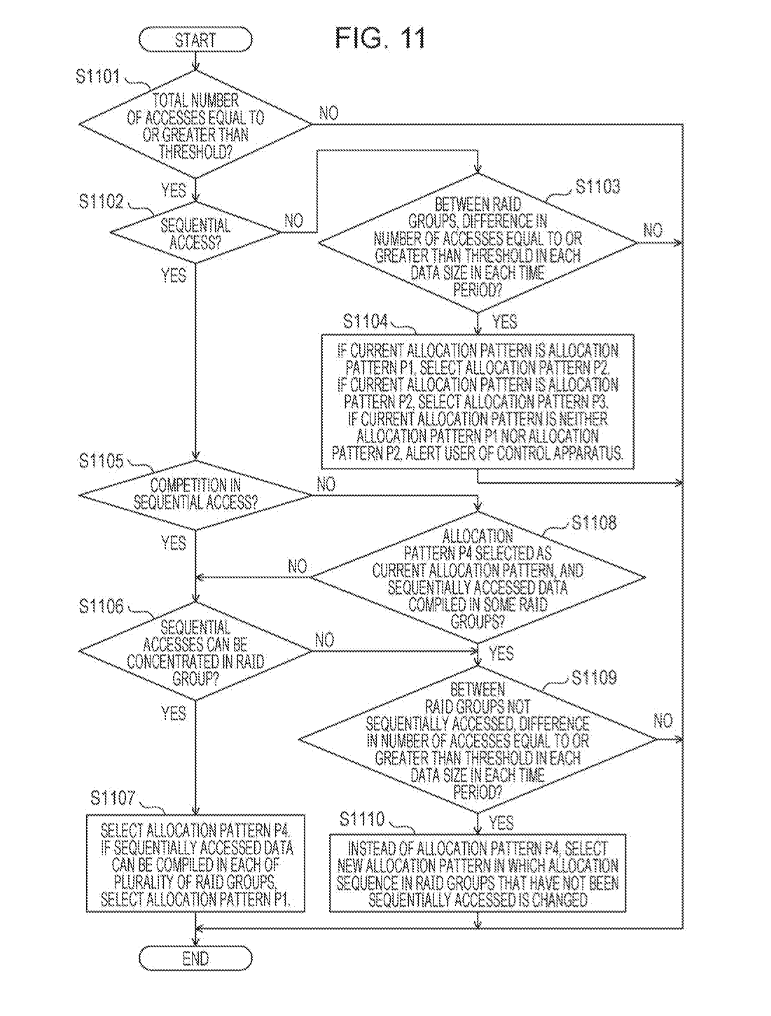

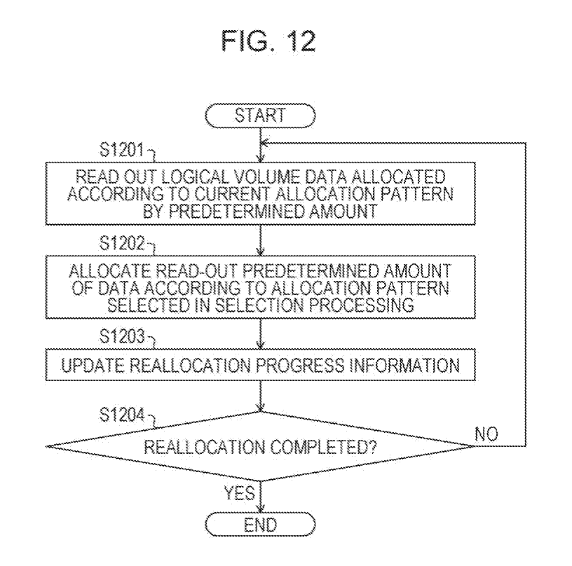

If the monitoring time has elapsed (the result in step S1002 is Yes), the control apparatus 100 decides whether the number of allocation pattern changes is equal to or greater than a threshold (step S1003). If the number of allocation pattern changes is smaller than the threshold (the result in step S1003 is No), the control apparatus 100 executes selection processing, which will be described later with reference to FIG. 11 (step S1004). Next, the control apparatus 100 executes reallocation processing, which will be described later with reference to FIG. 12 (step S1005). The control apparatus 100 then returns to processing in step S1001.

If the number of allocation pattern changes is equal to or greater than the threshold (the result in step S1003 is Yes), the control apparatus 100 alerts the user of the control apparatus 100 that the number of allocation pattern changes has reached or exceeded the threshold (step S1006). The control apparatus 100 then terminates the monitoring processing. Thus, the control apparatus 100 can reallocate logical volume data according to the access trend.

(Example of a Selection Procedure)

Next, a selection procedure executed in step S1004 will be described with reference to FIG. 11.

FIG. 11 is a flowchart illustrating an example of a selection procedure. In FIG. 11, the control apparatus 100 decides whether the total number of accesses is equal to or greater than a threshold (step S1101). If the total number of accesses is smaller than the threshold (the result in step S1101 is No), the control apparatus 100 terminates the selection processing.

If the total number of accesses is equal to or greater than the threshold (the result in step S1101 is Yes), the control apparatus 100 decides whether there is a sequential access (step S1102). If there is no sequential access (the result in step S1102 is No), the control apparatus 100 decides whether, between any two RAID groups, a difference in the number of accesses is equal to or greater than a threshold in each data size in each time period (step S1103).

If the difference is equal to or greater than the threshold (the result in step S1103 is Yes), the control apparatus 100 selects an allocation pattern according to the current allocation pattern; if the current allocation pattern is allocation pattern P1, the control apparatus 100 selects allocation pattern P2 (step S1104); if the current allocation pattern is allocation pattern P2, the control apparatus 100 selects allocation pattern P3 (step S1104).

If the current allocation pattern is neither allocation pattern P1 nor allocation pattern P2, the control apparatus 100 alerts the user of the control apparatus 100 (step S1104). The control apparatus 100 then terminates the selection processing. If the difference smaller than the threshold (the result in step S1103 is No), the control apparatus 100 terminates the selection processing.

If there is a sequential access (the result in step S1102 is Yes), the control apparatus 100 decides whether there is a competition in the sequential access (step S1105). If there is no competition in the sequential access (the result in step S1105 is No), the control apparatus 100 proceeds to processing in step S1108.

If there is a competition in the sequential access (the result in step S1105 is Yes), the control apparatus 100 decides whether sequential accesses can be concentrated in an RAID group (step S1106). If concentration of sequential accesses is not possible (the result in step S1106 is No), the control apparatus 100 proceeds to processing in step S1109.

If concentration of sequential accesses is possible (the result in step S1106 is Yes), the control apparatus 100 selects allocation pattern P4 (step S1107). Alternatively, if sequential accesses can be concentrated in each of a plurality of RAID groups, the control apparatus 100 selects allocation pattern P1 (step S1107). The control apparatus 100 then terminates the selection processing.

In step S1108, the control apparatus 100 decides whether the current allocation pattern is allocation pattern P4 and sequential accesses have been concentrated in some RAID groups (step S1108). If the current allocation pattern is not allocation pattern P4 or sequential accesses have not been concentrated in some RAID groups (the result in step S1108 is No), the control apparatus 100 proceeds to processing in step S1106.

If the current allocation pattern is allocation pattern P4 and sequential accesses have been concentrated in some RAID groups (the result in step S1108 is Yes), the control apparatus 100 proceeds to processing in step S1109.

In step S1109, the control apparatus 100 decides whether, between any two RAID groups that have not been sequentially accessed, a difference in the number of accesses is equal to or greater than a threshold in each data size in each time period (step S1109). If the difference is equal to or greater than the threshold (the result in step S1109 is Yes), the control apparatus 100 selects a new allocation pattern in which allocation sequence in RAID groups that have not been sequentially accessed is changed, the new allocation pattern being substituted for allocation pattern P4 (S1110). The control apparatus 100 then terminates the selection processing.

If the difference is smaller than the threshold (the result in step S1109 is No), the control apparatus 100 terminates the selection processing. Thus, if the changing condition is satisfied, the control apparatus 100 can select a substituted allocation pattern according to an access trend.

(Example of a Reallocation Procedure)

Next, a reallocation procedure executed in step S1005 will be described with reference to FIG. 12.

FIG. 12 is a flowchart illustrating an example of the reallocation procedure. In FIG. 12, the control apparatus 100 reads out logical volume data allocated according to the current allocation pattern by a predetermined amount (step S1201). Next, the control apparatus 100 then reallocates the read-out predetermined amount of data according to the allocation pattern selected in selection processing (step S1202). The control apparatus 100 then updates reallocation progress information (step S1203).

Next, the control apparatus 100 decides whether reallocation has been completed (step S1204). If reallocation has not been completed (the result in step S1204 is No), the control apparatus 100 returns to processing in step S1201. If reallocation has been completed (the result in step S1204 is Yes), the control apparatus 100 terminates the reallocation processing. Thus, the control apparatus 100 can reallocate logical volume data.

As described above, the control apparatus 100 can identify an access trend for each of a plurality of RAID groups according to access requests for logical volumes created in a plurality of RAID groups. Next, the control apparatus 100 can decide whether a logical volume satisfies a changing condition, according to an identified access trend for each of the plurality of RAID groups. If the control apparatus 100 decides that changing condition is satisfied, the control apparatus 100 can reallocate data in the logical volume according to a substituted allocation pattern. Thus, in a case in which, if logical volume data is allocated by using the current allocation pattern, a plurality of RAID groups would be unevenly accessed or an access competition would occur, the control apparatus 100 can change the allocation pattern. As a result, the control apparatus 100 can suppress uneven accesses to the plurality of RAID groups or an access competition and can thereby suppress a reduction in access performance and the wear of the RAID groups.

The control apparatus 100 can also identify the number of accesses to each of a plurality of RAID groups. If a difference in the number of accesses is greater than a threshold between any two RAID groups in a plurality of RAID groups, the control apparatus 100 decides that the first changing condition of the changing conditions is satisfied. Thus, by deciding whether there is unevenness in the number of accesses between any two RAID groups in a plurality of RAID groups, the deciding unit 403 can decide whether to change the allocation pattern for the logical volume data.

In a case in which the control apparatus 100 decides the first changing condition is satisfied, if logical volume data has been allocated according to the first allocation pattern, the control apparatus 100 can reallocate the logical volume data according to the second allocation pattern. Thus, the control apparatus 100 can equalize the number of accesses to each of a plurality of RAID groups.

In a case in which the control apparatus 100 decides the first changing condition is satisfied, if logical volume data has been allocated according to the second allocation pattern, the control apparatus 100 can reallocate the logical volume data according to the third allocation pattern. Thus, the control apparatus 100 can equalize the number of accesses to each of a plurality of RAID groups.

The control apparatus 100 can also identify the presence or absence of a sequential access competition in each of a plurality of RAID groups. If there is a sequential access competition in any one of a plurality of RAID groups, the control apparatus 100 can decide that the second changing condition of the changing conditions is satisfied. Thus, by deciding whether there is a sequential access competition in any one of a plurality of RAID groups, the deciding unit 403 can decide whether to change the allocation pattern for the logical volume data.

In a case in which the control apparatus 100 decides that the second changing condition is satisfied, if sequentially accessed data can be concentrated in any one of a plurality of RAID groups, the allocating unit 404 can also reallocate logical volume data according to the fourth allocation pattern. Thus, the control apparatus 100 can equalize the number of accesses to each of a plurality of RAID groups and can also increase efficiency by enabling sequential access to be performed in any one of the plurality of RAID groups.

The control apparatus 100 can also identify the number of accesses to each of a plurality of RAID groups and the presence or absence of a sequential access competition in each of the plurality of RAID groups. Next, the control apparatus 100 can decide whether there is a sequential access competition in any one of the plurality of RAID groups. The control apparatus 100 can also decide whether a difference in the number of accesses is greater than a threshold between any two RAID groups in the remaining RAID groups. If there is a sequential access competition and a difference in the number of accesses is greater than the threshold, the control apparatus 100 can decide that the third changing condition of the changing conditions is satisfied. Thus, the deciding unit 403 can decide whether to change the allocation pattern for the logical volume data.

In a case in which the control apparatus 100 decides that the third changing condition is satisfied, if sequentially accessed data can be concentrated in any one of a plurality of RAID groups, the control apparatus 100 can reallocate logical volume data according to the fifth allocation pattern. Thus, the control apparatus 100 can equalize the number of accesses to each of a plurality of RAID groups and can also increase efficiency by enabling sequential access to be performed in any one of the plurality of RAID groups.

The control apparatus 100 further identifies a total number of accesses to a plurality of RAID groups according to access requests. If the identified total number is greater than a threshold, the control apparatus 100 can decide whether a changing condition is satisfied. Thus, if a total number of accesses to a plurality of RAID groups is smaller than the threshold and performance of accesses to logical volumes is not easily lowered in spite of an allocation pattern being left unchanged, the control apparatus 100 can leave the allocation pattern unchanged. As a result, the control apparatus 100 can reduce a load on data reallocation in a logical volume.

The control method described in this embodiment can be implemented by causing a personal computer, a workstation, or another type of computer to execute a control program prepared in advance. The control program may be recorded on a hard disk, a flexible disk, a compact disc-read-only memory (CD-ROM), a magneto-optic (MO) disk, a digital versatile disk (DVD), or another type of computer-readable recording medium, after which the control program may be read out by a computer to execute the control program. The control program may be distributed through the Internet or another network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control apparatus that controls allocation of data included in a logical volume so that the data is allocated in a plurality of physical storage areas, which have been assigned so as to span a plurality of RAID groups, according to a predetermined allocation pattern, the control apparatus comprising:
a storage unit that stores correspondence information that includes at least one changing condition under which an allocation pattern for the data is changed and a new allocation pattern substituted for the allocation pattern in correspondence to each other; and
a control unit that
identifies an access trend for each of the plurality of RAID groups that are accessed in response to access requests for the logical volume,
decides whether the logical volume satisfies the at least one changing condition, according to the correspondence information and the identified access trend, and
reallocates, if the control unit decides that the at least one changing condition is satisfied, the data included in the logical volume according to the new allocation pattern corresponding to the at least one changing condition.

2. The control apparatus according to claim 1, wherein:
the control unit identifies a number of accesses to each of the plurality of RAID groups; and
if a difference in the number of accesses is greater than a threshold between any two RAID groups in the plurality of RAID groups, the control unit decides that a first changing condition of the at least one changing condition is satisfied.

3. The control apparatus according to claim 2, wherein, in a case in which the control unit decides that the first changing condition is satisfied, if data in the logical volume to be reallocated has been contiguously distributed and allocated across the plurality of RAID groups, the control unit reallocates the data to be reallocated according to an allocation pattern by which a predetermined amount of data in the data to be reallocated is distributed to and reallocated in each RAID group at a time so that the data is contiguously distributed and allocated across the plurality of RAID groups.

4. The control apparatus according to claim 2, wherein, in a case in which the control unit decides that the first changing condition is satisfied, if data in the logical volume to be reallocated has been contiguously distributed and allocated across the plurality of RAID groups, the control unit reallocates the data to be reallocated according to an allocation pattern by which an order in which the data to be reallocated is allocated across the plurality of RAID groups is changed.

5. The control apparatus according to claim 1, wherein:
the control unit identifies presence or absence of a sequential access competition in each of the plurality of RAID groups; and
if there is a sequential access competition in any one of a plurality of RAID groups, the control unit decides that a second changing condition of the at least one changing condition is satisfied.

6. The control apparatus according to claim 5, wherein, in a case in which the control unit decides that the second changing condition is satisfied, if data that is involved in sequential accesses and is to be reallocated, the data being part of the data included in the logical volume, is capable of being allocated in any one of the plurality of RAID groups in a concentrated manner, the control unit reallocates the data included in the logical volume according to an allocation pattern by which the data that is involved in sequential accesses and is to be reallocated is allocated in any one of the plurality of RAID groups and remaining data in the data included in the logical volume is distributed to and allocated in remaining RAID groups in the plurality of RAID groups.

7. The control apparatus according to claim 1, wherein:
the control unit identifies a number of accesses to each of the plurality of RAID groups and presence or absence of a sequential access competition in each of the plurality of RAID groups; and
if there is a sequential access competition in any one of the plurality of RAID groups and a difference in the number of accesses is greater than a threshold between any two RAID groups in the remaining RAID groups, the control unit decides that a third changing condition of the at least one changing condition is satisfied.

8. The control apparatus according to claim 7, wherein, in a case in which the control unit decides that the third changing condition is satisfied, if data that is involved in sequential accesses and is to be reallocated, the data being part of the data included in the logical volume, is capable of being allocated in any one of the plurality of RAID groups in a concentrated manner, the control unit reallocates the data included in the logical volume according to an allocation pattern by which the data that is involved in sequential accesses and is to be reallocated is allocated in any one of the plurality of RAID groups and a predetermined amount of data in remaining data in the data included in the logical volume is distributed to and allocated in each RAID group in remaining RAID groups in the plurality of RAID groups at a time so that the data is contiguously distributed and allocated across the remaining RAID groups.

9. The control apparatus according to claim 1, wherein:
the control unit further identifies a total number of accesses to the plurality of RAID groups in response to the access requests; and
if the total number of accesses is greater than a threshold, the control unit decides whether the at least one changing condition is satisfied.

10. A control method in which a control apparatus, which controls allocation of data included in a logical volume so that the data is allocated in a plurality of physical storage areas, which have been assigned so as to span a plurality of RAID groups, according to a predetermined allocation pattern, performs processing to
identify an access trend for each of the plurality of RAID groups that are accessed in response to access requests for the logical volume,
decide whether the logical volume satisfies the at least one changing condition, according to the access trend identified for each of the plurality of RAID groups and to correspondence information that includes at least one changing condition under which an allocation pattern for the data is changed and a new allocation pattern substituted for the allocation pattern in correspondence to each other, the correspondence information being stored in a storage unit, and
reallocate, if the control unit decides that the at least one changing condition is satisfied, the data included in the logical volume according to the new allocation pattern corresponding to the at least one changing condition.

11. A non-transitory and computer-readable storage medium storing a control program that causes a control apparatus to execute processing, the control apparatus controlling allocation of data included in a logical volume so that the data is allocated in a plurality of physical storage areas, which have been assigned so as to span a plurality of RAID groups, according to a predetermined allocation pattern, wherein the processing comprising;
identifying an access trend for each of the plurality of RAID groups that are accessed in response to access requests for the logical volume,
deciding whether the logical volume satisfies at least one changing condition, according to the access trend identified for each of the plurality of RAID groups and to correspondence information that includes the at least one changing condition under which an allocation pattern for the data is changed and a new allocation pattern substituted for the allocation pattern in correspondence to each other, the correspondence information being stored in a storage unit, and
reallocating, if the control unit decides that the at least one changing condition is satisfied, the data included in the logical volume according to the new allocation pattern corresponding to the at least one changing condition.
